(19) United States
(12) Patent Application Publication
(10) Pub. No.: US 2024/0140128 A1
(43) Pub. Date: May 2, 2024

(54) ANTI-STRESS PEN WITH THE ABILITY TO STIMULATE THE PALM NERVES

(71) Applicant: Seyedvahid TORABI, Jahrom (IR)

(72) Inventor: Seyedvahid TORABI, Jahrom (IR)

(21) Appl. No.: 18/281,209

(22) PCT Filed: Mar. 3, 2022
(86) PCT No.: PCT/IB2022/051862

§ 371 Date: Sep. 8, 2023

(30) Foreign Application Priority Data
Mar. 11, 2021 (IR) 13995014000301111

(51) Int. Cl. B43K 5/00

(52) U.S. Cl. CPC B43K 5/005

(57) ABSTRACT

The anti-stress pen is designed in a way that its body is divided into two equal parts or proportional to the hand in two unequal parts and is capable of stimulating the nerves of the palm. By moving the pocket head clamp downwards, the lower part of the pen body, which has a small tooth, is moved by transfer and rotation. The pen is designed focusing on a population of pen users who are accustomed to playing with the pen body. The nerves in the fleshy part of the palm were considered. When we work with the pen pocket head clamp, the lower part of it massages the palm. Scientifically, the palmar nerves are related to digestive glands which reduce stress; then, by producing the pen, we can improve digestive function and reduce stress via stimulating the nerves. A graphical abstract is also presented in drawings file.

The purpose of designing an anti-stress pen with the ability to stimulate the nerves of the palm of the hand is to use this pen whenever we do not use it for writing. It can be used for hand massages and entertainment. Many people are accustomed to playing with chassis of pressure pens. In the design of the pen, this issue has been taken into account.

This invention is inspired by ancient acupressure. The anti-stress pen with the ability to stimulate the nerves of the palm is designed in such a way that it restores calmness to the person by pressing and massaging two points in the palm. Those who are accustomed to playing with the pen chassis and playing with the fingers can also use this device. Therefore, this pen has a kind of therapeutic and entertainment mode.

### TECHNICAL FIELD

medicine, entertainment, psychology, mechanics

### BACKGROUND ART

Spinner with patent registration number, U.S. D 603,226 S-U.S. Pat. No. 10,016,693 BI
pen with massaging function No: CN106626878A
prevent pen that cap loses No: CN205416838U
mesh ball patent registration number, mesh ball U.S. D578,253 S 1

### SUMMARY OF INVENTION

The clamp part of the pen is movable; by moving it down, it moves the lower body of the anti-stress pen with the ability to stimulate the nerves of the palm. In addition to writing, this pen can be used to reduce and treat stress. This pen is designed in such a way that by pushing its pocket head clamp downwards, the lower part of the body, which has small protrusions and grooves, goes up and down, and while rotating, it massages some points in the palm of the hand.

In terms of acupressure, a point in the center of the palm can be effective in reducing gastrointestinal stress. A point in the fleshy part of the palm is related to the function of the endocrine glands and the heart. The size and design of this pen allows it to press and massage both points. It also suppresses stress and anxiety and treats stress while increasing concentration.

### Technical Problem

The problem was with pens in hands of individuals who tend to experience stress and anxiety when they face special circumstances such as an important meeting, a conference, etc. or they are in a situation with a pen in their hand and nothing to do.

### Solution to Problem

The solution is to entertain them unconsciously with the pen to diminish the stress and to convey the feelings of hormonal and physiological peace to the user of the pen, to improve their function and to bring effectiveness to their moments.

### Advantageous Effects of Invention

The innovation of the anti-stress pen with the ability to stimulate the nerves of the palm shows some

### Advantageous Effects

1—It is very easy to hold and be used.
2—It will relieve emotions and reduce stress by using repetitive movements and stimulating the fingers and palms.
3—It can be used for massaging the desired area in the hand, cures stress and increases concentration.
4—It is very cheap.
5—Due to its size, it is very easy to carry and maintain.

### BRIEF DESCRIPTION OF DRAWINGS

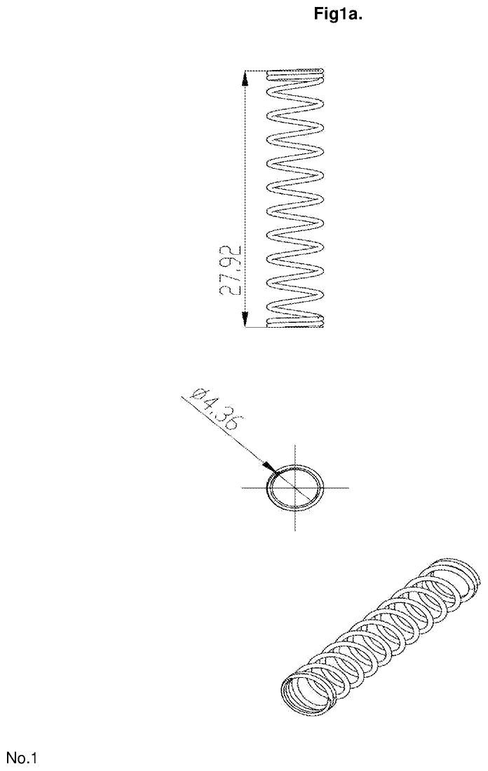

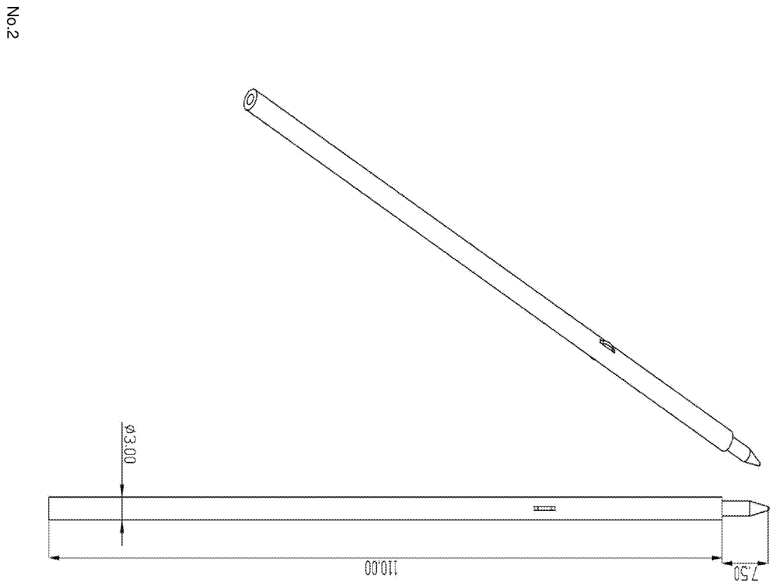

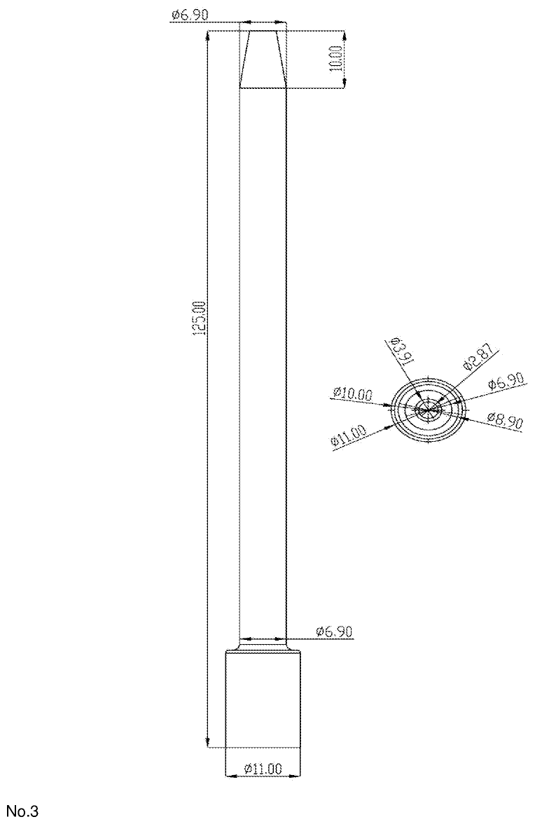

### FIG. 1

FIG. 1a. Illustrates the components of the pen as drawings

FIG. 1b. Illustrates the components of the pen

In FIG. 1, numbers 1 to 6 form the components of the pressure pen. No. 1 depicts a spring which is placed on No. 2 is the pen tube. In the next step, we put the pen tube and spring in the body of pen, No 3. Then pieces depicted in No. 4 and 5 are placed in the piece depicted in No. 6, respectively. And this collection is also closed on the body of the pen (No. 3). Now, the pressure pen is ready.

The other parts are as follows:
No. 7—A spring that is placed on the upper part of the middle body.
No. 8—The upper part of the middle body.
No. 9—The lower part of the middle body.
No. 10—A pin that is placed on the middle body and its two arms pass through the guide groove and are connected to the upper body.
No. 11—Pocket head clip.
No. 12—The upper part of the upper body.
No. 13—The lower part of the upper body.

### DESCRIPTION OF EMBODIMENTS

In the design of the anti-stress pen with the ability to stimulate the nerves of the palm, its size (13 to 17 cm) and its thickness are considered in accordance with the size of the hand. This pen has three bodies. The upper and middle body of this pen is divided into two parts. The lower body, which is actually the body of the pressure pen, is one piece (like a normal pen body)

The two surfaces of the upper body are connected in a way, which allows the end to move and rotate. The two surfaces of the upper body are highlighted with grooves and teeth. These grooves and teeth are felt in the hand. In fact, it stimulates the nerves of the palms and fingertips when moving. The figure below shows the full view of the anti-stress pen which has the ability to stimulate the nerves of the palm.

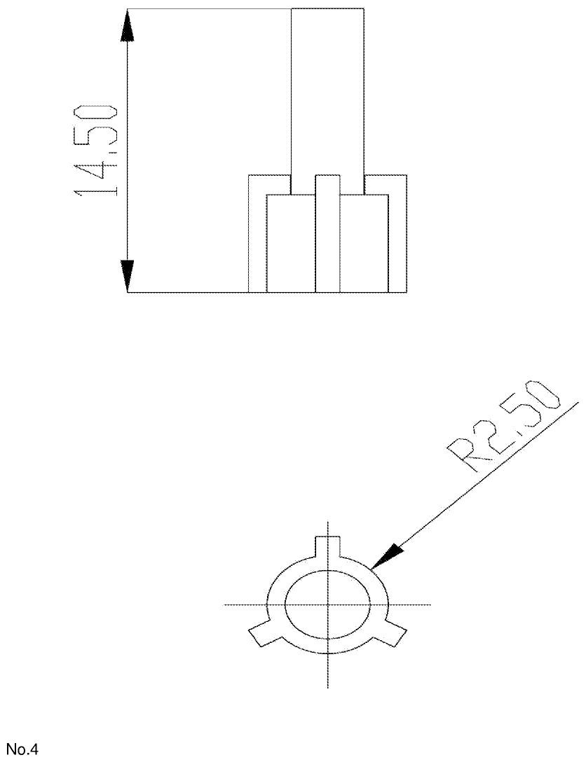

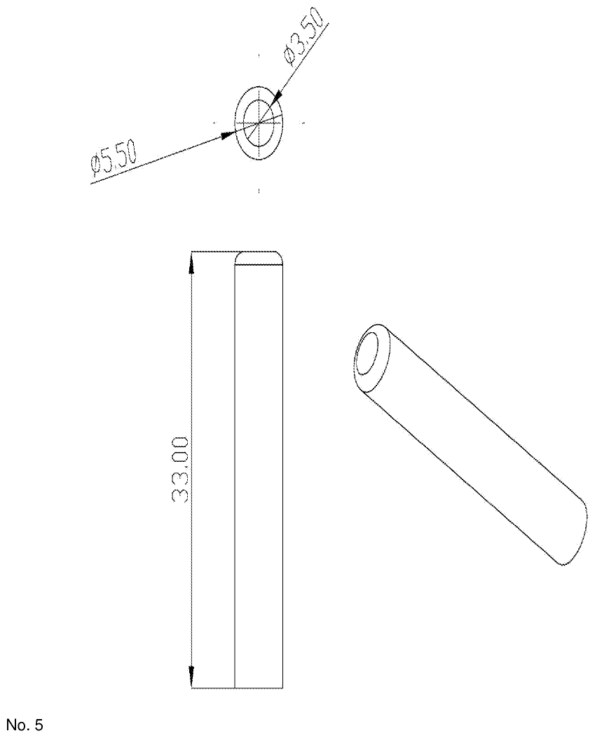

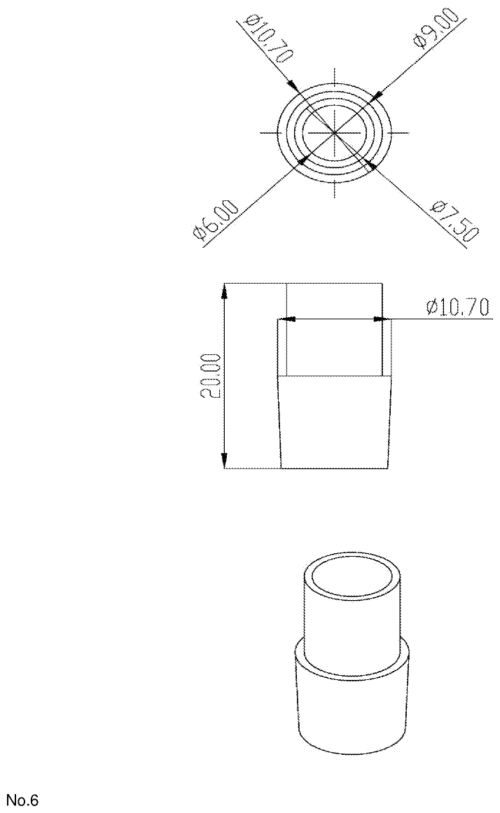

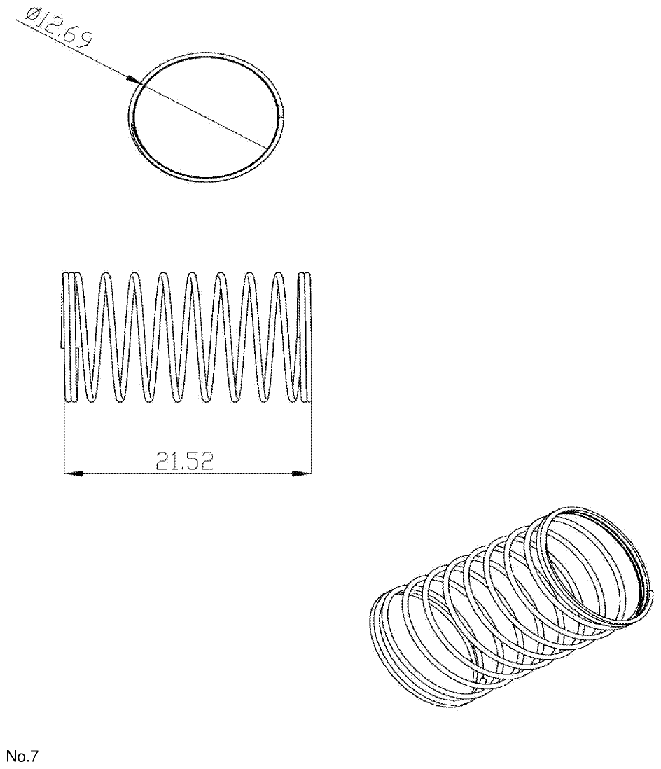

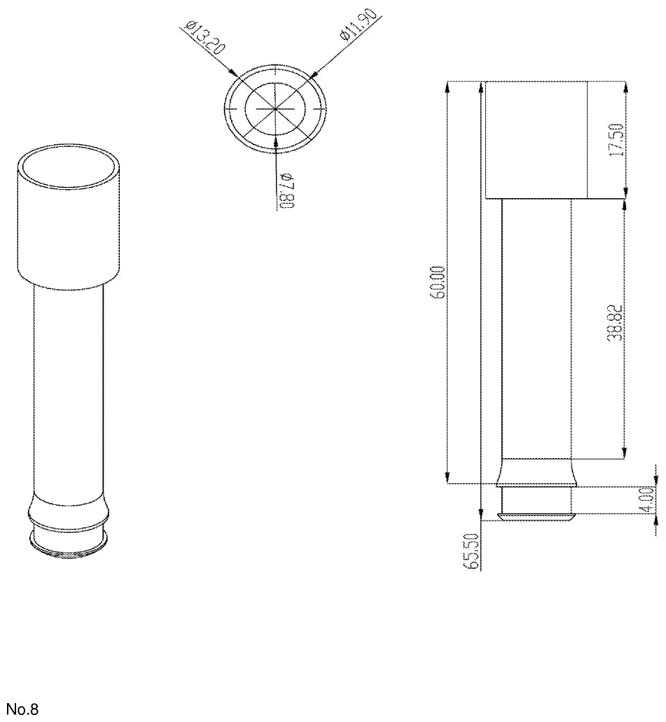

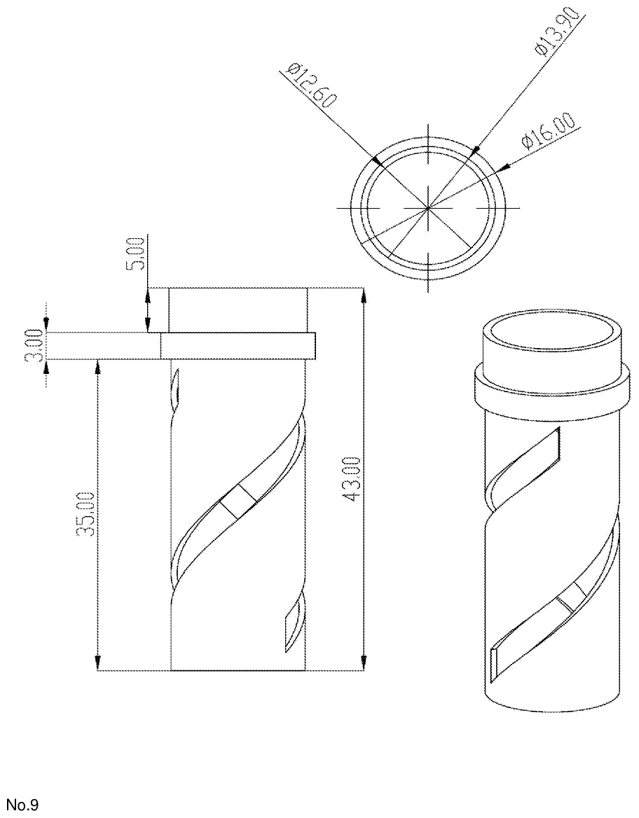

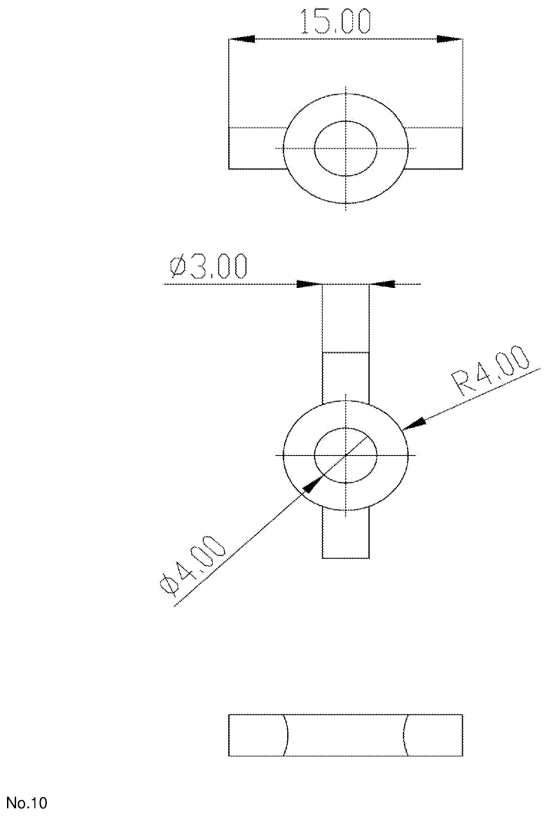

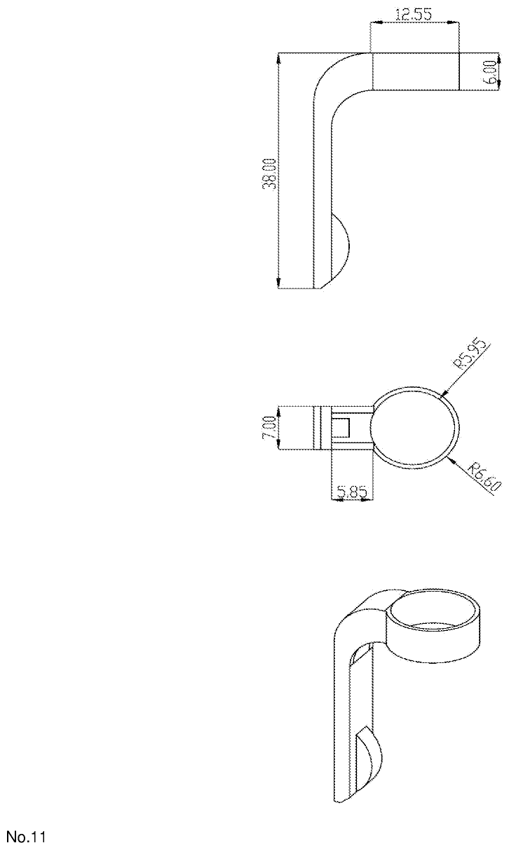

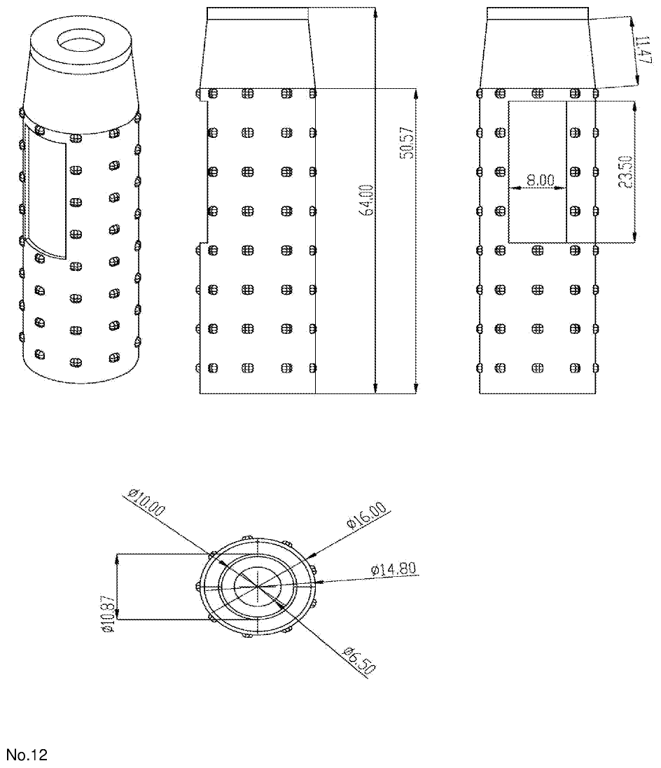

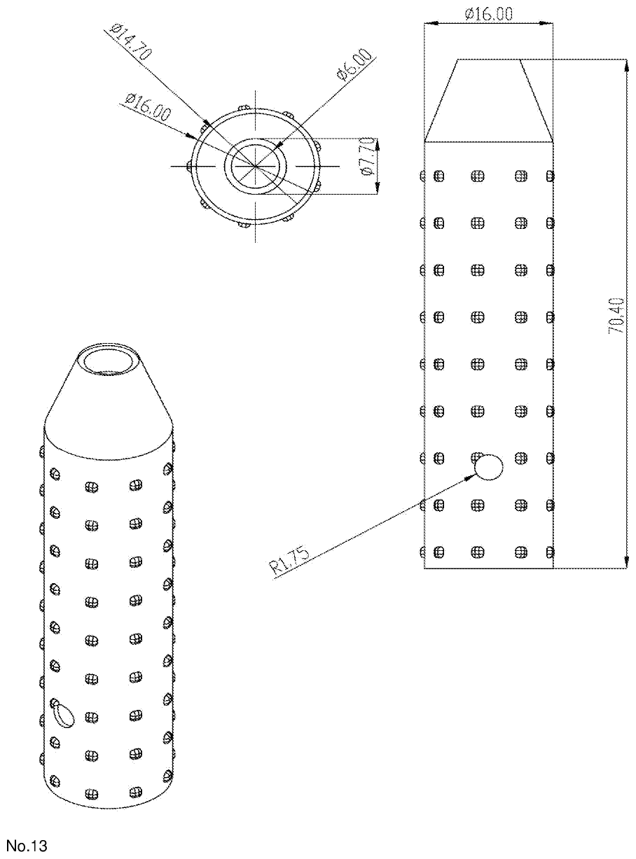

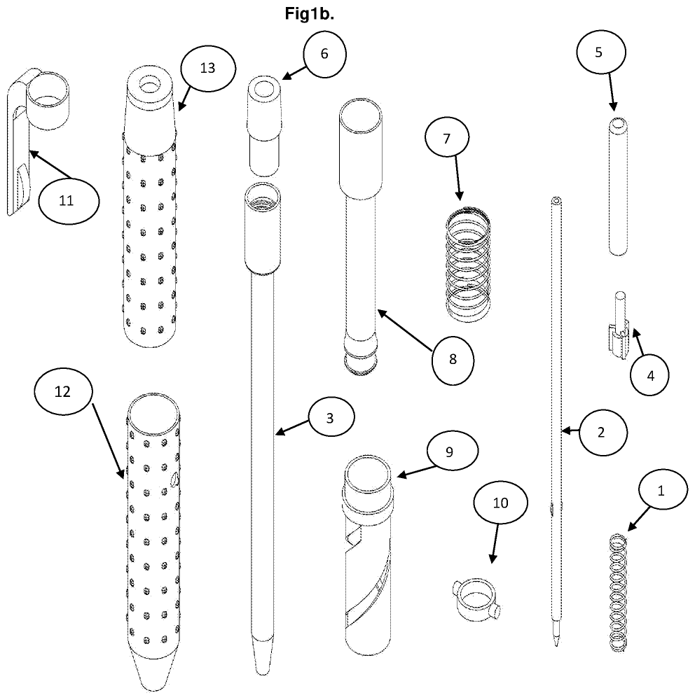

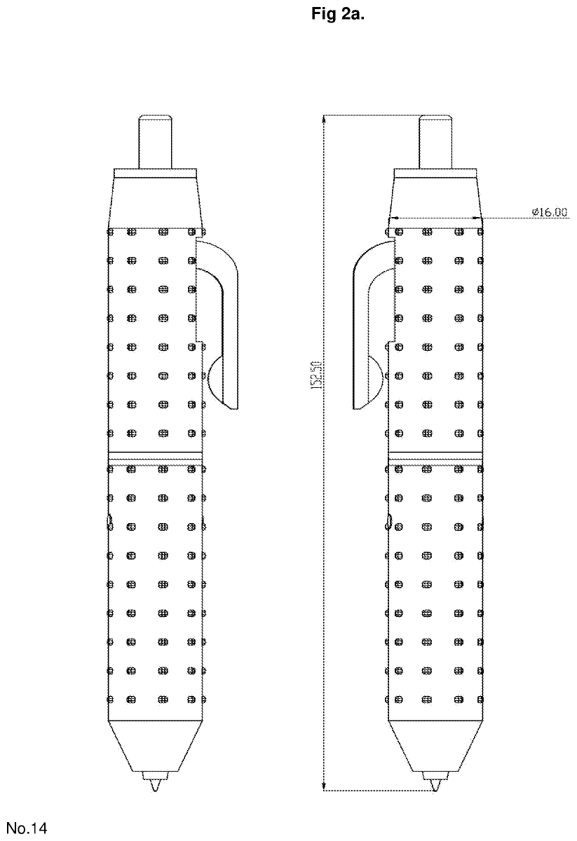

### FIG. 2

FIG. 2a. illustrates Drawings of the Full View of the Anti-stress Pen

FIG. 2b. illustrates the Full View of the Anti-stress Pen

The underside body of the anti-stress pen with the ability to stimulate the nerves of the palm is narrower than the body of a normal pen due to its position in the main body. As shown below.

### FIG. 3

FIG. 3. illustrates the Inner Body of the Anti-stress Pen

In FIG. 3, spring No. 1 is located at the bottom of the pen tube No. 2, behind the teeth on the pen tube. The tube is placed with the spring inside the body of the pen (No. 3). No. 4 is located behind No. 5 and both are located in part No. 6. We close these three sets, namely numbers 4, 5, and 6, on the main body (No. 3) and at the end of it. To make an anti-stress pen with the ability to stimulate the nerves of the palm, we place the middle body, which is two parts, on the body of the pressure pen.

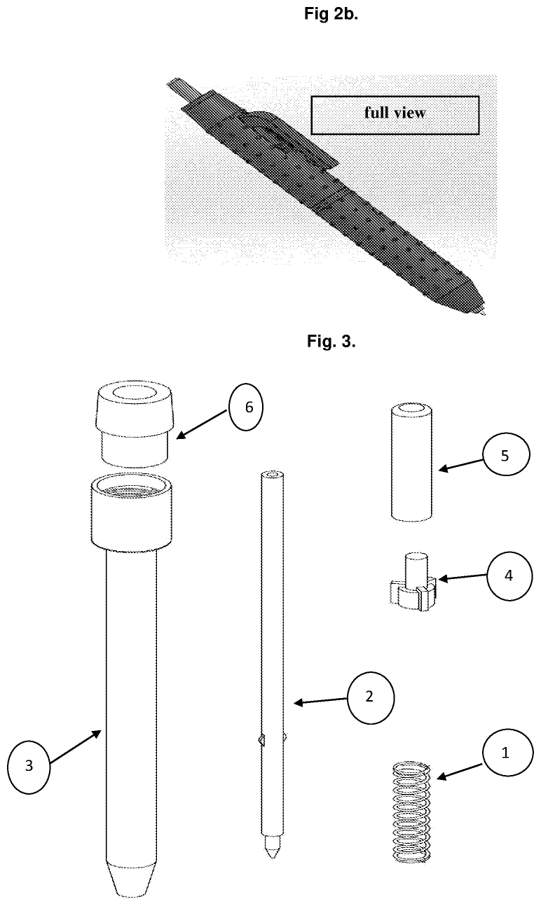

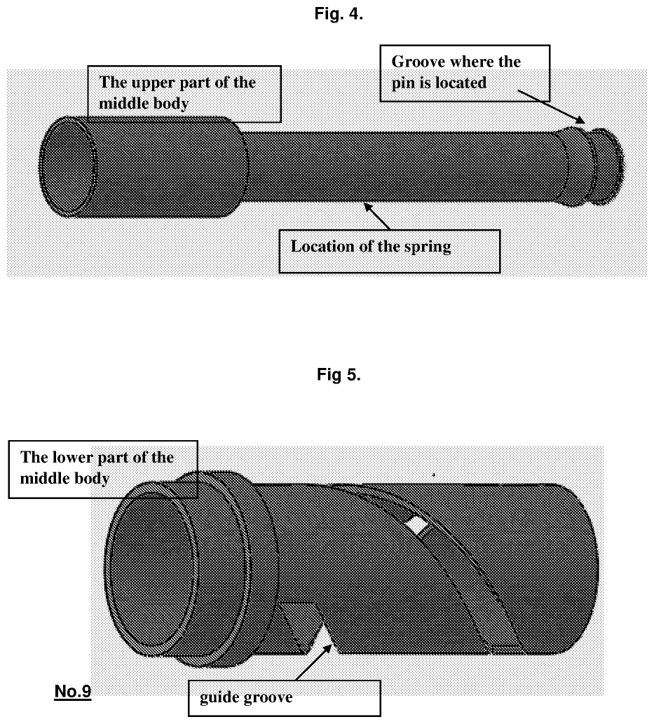

The two parts of the middle body (No. 8 (in FIG. 4) and 9) are connected by pins. First, we place the spring on the upper part of the middle body. At the bottom of the upper middle body, there is a groove, which is responsible for connecting the pin.

### FIG. 4

FIG. 4. illustrates component No. 8 of the Pen

FIG. 5 depicts the lower part of the middle body which has a guide groove (No. 9). Two pin arms move through this groove, and attaches to the upper body. And the pocket head clip is located behind the middle body. When we move it down, pressure is applied to the middle body and the pin moves inside the guide groove.

Due to the fact that the two pin arms are connected to the upper body, it moves it by transient and rotational motion.

### FIG. 5

FIG. 5. illustrates Depicting the Spring and the Lower Part of the Body

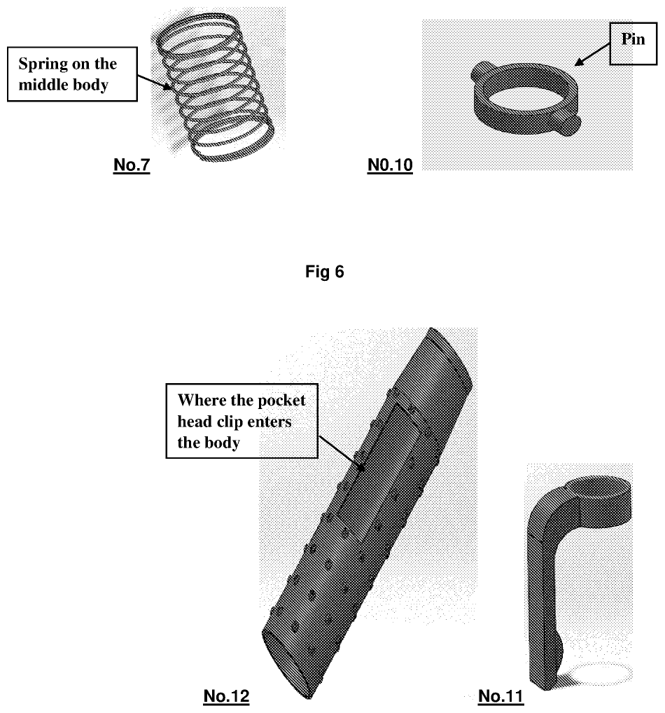

First, we put spring, No. 7, on the middle body (place specified in No. 8). The function of this spring is to return the movement of the pocket head clamp in its place. And then we enter the pin in the lower part of the middle body (No. 9) in such a way that two pin arms are out of the guide groove. Based on FIG. 6, to insert this set inside the upper body, first insert the pocket head clamp (No. 11) inside the upper body (No. 12) and from the slot.

### FIG. 6

FIG. 6. Illustrates the Pocket Head Clamp and the Upper Body

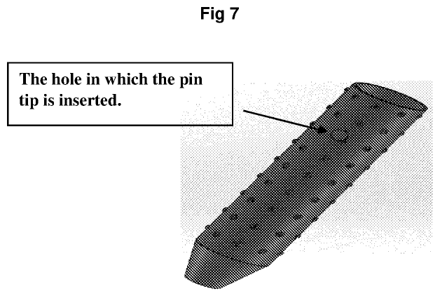

The pocket head clamp is located behind the middle body, and when we pull the pocket head clamp down, it pushes the middle body down. The function of the spring is to return the middle body and the clamp to its original position. In the next step, we will install the lower part of the upper body. In this way, there are two holes in the lower body of the upper part, and two pin arms are placed in those two holes (refer to FIG. 7).

### FIG. 7

FIG. 7. Illustrates component No. 13: The Hole in which the Pin Tip is Inserted

### INDUSTRIAL APPLICABILITY

Pens are considered as the most common tools to be used for writing, but the use of a pen fidget capable of massaging the nerves of the palm used intentionally or unintentionally for stress reduction can improve the effectiveness of the user while writing or playing with it.

This invention is used in the medical and psychotherapeutic industry and obviously as stationery.

### PATENT LITERATURE

[1] Karlesky, M., & Isbister, K. (2013). Fidget widgets: secondary playful interactions in support of primary serious tasks. In CHI'13 Extended Abstracts on Human Factors in Computing Systems (pp. 1149-1154).
[2] Fogal, B., McGrath, C., Ramos, C., Stanley, A., Sturman, D., Addison, W. B., & Towner Jr, W. T. (2017). Design and Analysis of Cognitive Focus Devices (Doctoral dissertation, Tesis Doctoral. Worcester Polytechnic Institute. Disponible en https://web.wpi.edu/Pubs/E-project/Available/E-project-032317-123222/unrestricted/Fidget_Widget_MQP.pdf).
www.pinterest.com/amp/pin/451345193877161795/

### EXPLANATION OF OTHER DOCUMENTS

A questionnaire was prepared in connection with the claim and the results of this questionnaire are attached.

1. What is claimed is a pen that can give massages and is used as a fidget, with grooves and bumps on the body of the pen that stimulate the nerves at the bottom of the palm. The body of the pen is divided into two equal parts or proportional to the hand in two unequal parts. It fits the hand and the lower part of the pen body is movable, which moves with the movement of the clamp with two transient and rotational movements, and is composed of the following components:
1—The lower body of the pen is a pressure pen.
2—The middle body is divided into two parts and includes the following components:
The pin that passes through the guide groove at the bottom of the middle body and connects to the upper body
The clamp is located at the top of the middle body.
The upper body has a pin on it
The lower part of the middle body on which the guide groove is to pass the pin through it.
A spring is placed on the upper part of the middle body to turn the clamp.
3—The upper body is divided into two parts and the upper part is fixed and the lower part is movable due to the connection to the pin.

2. According to claim 1, a pin is used to move the lower part of the upper body. Due to the movement through the guide groove in the lower part of the middle body, the transfer motion of the clamp becomes a rotational and transfer motion.

3. According to claim 1, the bumps created on the main body bring feelings of beings massaged and stimulate of the nerves at the bottom of the palm, which according to medical records calms and improves the function of the gastrointestinal tract.
